(19) United States
(12) Patent Application Publication
(10) Pub. No.: US 2011/0142396 A1
(43) Pub. Date: Jun. 16, 2011

(54) ATHERMAL SILICON PHOTONICS ARRAY WAVEGUIDE GRATING (AWG) EMPLOYING DIFFERENT CORE GEOMETRIES IN THE ARRAY WAVEGUIDES

(75) Inventor: Katsunari OKAMOTO, Ibaraki (JP)

(73) Assignee: AIDI CORPORATION, Ibaraki (JP)

(21) Appl. No.: 12/899,715

(22) Filed: Oct. 7, 2010

Related U.S. Application Data
(60) Provisional application No. 61/249,268, filed on Oct. 7, 2009.

(51) Int. Cl. G02B 6/34; G02B 6/124

(52) U.S. Cl. 385/37; 264/1.24

(57) ABSTRACT

A silicon photonics array waveguide grating (AWG), and methods of their manufacture, including a plurality of silicon photonics array waveguides running from at least one of an input and output slab waveguide region, wherein first sections of each of the plurality of array waveguides have a first core geometry; and second sections of each of the plurality of array waveguides have a second core geometry. The first and second core geometries may comprise different waveguide core widths, and/or different core structures. AWG temperature stability is provided by the techniques of the present invention.

### RELATED APPLICATION INFORMATION

This application claims the benefit of U.S. Provisional Application Ser. No. 61/249,268 filed Oct. 7, 2009, entitled ATHERMAL SILICON PHOTONICS ARRAY WAVEGUIDE GRATING (AWG) EMPLOYING DIFFERENT CORE GEOMETRIES IN THE ARRAY WAVEGUIDES. This Provisional application is hereby incorporated by reference herein in its entirety.

### TECHNICAL FIELD

The present invention relates to an athermal (temperature insensitive) silicon photonics AWG. More particularly, the present invention relates to a novel AWG configuration employing different (e.g., two) core geometries in the array waveguides.

### BACKGROUND OF THE INVENTION

Silicon photonics is attracting increasing attention, because it offers an entirely new generation of low-cost photonic integrated circuits, which will perform functions traditionally accomplished using much more expensive components based on type III-V semiconductor materials. The primary driving force for silicon photonics development is the demand for cost effective optical interconnect technology in the microelectronics industry. Silicon photonics could also find a wider range of applications beyond optical communications applications.

By integrating fundamental building blocks (such as light sources, optical waveguides, AWG multi/demultiplexers, optical modulators, light detectors, and electronic intelligence) on a single silicon substrate, a silicon photonic chip is enabled that has both electronic and photonic functionalities with many performance and cost benefits when compared to devices based on discrete components.

Significant technology breakthroughs in the field of silicon photonics have occurred in the last few years. Various silicon photonic components such as silicon optical modulators, SiGe photo-detectors, silicon Raman lasers, silicon optical amplifiers, silicon wavelength converters, and hybrid silicon lasers have been demonstrated.

The most critical issue confronting silicon photonics AWG implementation is that the demultiplexing properties vary with temperature. Unlike silica AWGs currently used in telecommunication applications, thermo-optic controllers or mechanical techniques cannot be used to stabilize device performance, because silicon photonics AWGs may be extremely small (˜100 μm×100 μm) and surrounded by heat generating CPUs. Athermalization of the AWG itself is therefore extremely important to the development of CMOS-compatible silicon photonics.

As disclosed further below. The present invention provides techniques for desensitizing the silicon photonics AWG to temperature variations, by employing different core geometries in the array waveguides.

Presently, this problem is solved, for example, by using an SOI (silicon on insulator) waveguide with polymer over-cladding as shown in FIGS. 1 and 2 (J. Teng, et. al., “A thermal Silicon-on-insulator ring resonators by overlaying a polymer cladding on narrowed waveguides”, Optics Express, vol. 17, no. 17, pp. 14627-14633, 2009). In this technique, temperature dependence of the silicon core (dn_{Si}/dT=1.83×10⁻⁴ K⁻¹) is canceled out by the opposite temperature sensitivity of the polymer over-cladding (dn_{Poly}/dT=−2.4×10⁻⁴ K⁻¹).

An AWG works much like a phased array antenna operating at optical frequencies. With reference to the schematic of an exemplary AWG of FIG. 3, this AWG includes input and output waveguides, two focusing slab regions, and a phased-array of multiple channel waveguides with a constant path length difference ΔL between neighboring waveguides.

As FIG. 3 illustrates, the input light at the position of x₁ enters the first slab waveguide and then excites the arrayed waveguides. The excited field at each array waveguide is aₖ (k=1˜N), where N denotes the total number of array waveguides. After traveling through the arrayed waveguides, the light beams constructively interfere onto one focal point at x in the second slab waveguide. The location of this focal point depends on the signal wavelength since the relative phase delay in each waveguide is given by ΔL/λ. The dispersion of the focal position x with respect to the wavelength 2 for the fixed light input position x₁ is given by K. Okamoto, Fundamentals of Optical Waveguides, 2nd Edition (Elsevier, New York, 2006) chapter 9, as:

$$\frac{Δ x}{Δ λ} = \frac{mf}{{n}_{s} d} , \qquad ( 1 )$$

where f and nₛ (=βₛ/k) are the focal length and effective index of the slab region, d is an array waveguide separation at the second slab and array interface, and m is diffraction order. The center wavelength of an AWG is given by:

$$λ = \frac{{n}_{c} Δ L}{m} , \qquad ( 2 )$$

where n_{c} (=β_{c}/k) is the effective index of the array waveguide, and ΔL is the geometrical path-length difference in the array arms.

FIG. 4 shows the temperature dependence of the center wavelength obtained on a 32 channel 100-GHz SOI AWG in which core width W=500 nm, over-cladding is SiO₂ and the rest of the parameters are similar to those shown in FIG. 1.

The temperature sensitivity of center wavelength can be expressed as:

$$\frac{d λ}{d T} \sim 0.12 nm \text{/} K . \qquad ( 3 )$$

FIG. 5 shows temperature dependence of the center wavelength obtained on a 32 channel 100-GHz SOI AWG with core width W=350 nm and polymer over-cladding as shown in FIGS. 1 and 2.

Temperature sensitivity is reduced from 0.12 nm/K to −0.005 nm/K because the negative temperature sensitivity of the polymer cancels out the positive sensitivity of the silicon core.

There are generally two types of CMOS integration schemes: front-end-of-line (FEOL) integration (as shown in the example of FIG. 6) and back-end-of-line (BEOL) integration (as shown in the example of FIG. 7). In FEOL integration, polymer over-cladding for SOI optical waveguide devices is not practical because polymer over-cladding may not have accurate thickness controllability required in the successive processes and may add contamination to the electronics devices.

In BEOL integration, optical waveguide devices will be placed over the CMOS devices. The main reason for this is that type III-V semiconductor devices such as InGaAsP lasers and detectors will be wafer bonded onto the silicon optical core directly. In such cases, there is no opportunity to add polymer over-cladding to silicon optical devices.

Based upon the above discussion, athermal silicon photonics AWGs, preferably without polymer materials, are required in this field.

### SUMMARY OF THE INVENTION

The shortcomings of the prior art are overcome and additional advantages are provided by the present invention, which in one aspect is a silicon photonics array waveguide grating and a method of its manufacture. The grating includes a plurality of silicon photonics array waveguides running from at least one of an input and output slab waveguide region, wherein first sections of each of the plurality of array waveguides have a first core geometry; and second sections of each of the plurality of array waveguides have a second core geometry.

In one aspect, the first and second core geometries comprise different waveguide core widths.

The second section of each of the plurality of array waveguides may be a central section thereof; wherein the second core size is greater than the first core size, and the path length of the plurality of array waveguides increases from an outer to an inner waveguide and the path length of each second section of each of the plurality of array waveguides decreases from the outer to the inner waveguide.

In another aspect, the first core geometry comprises a homogenous waveguide structure and the second core structure comprises a slot waveguide structure.

The second section of each of the plurality of array waveguides may be a central section thereof; and the path length of the plurality of array waveguides increases from an outer to an inner waveguide and the path length of each second section of each of the plurality of array waveguides decreases from the outer to the inner waveguide.

The array waveguide gratings may be dual-slab configurations, or reflection-type configurations having a single slab.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in connection with the accompanying drawings in which:

FIG. 1 is a cross sectional view of a typical SOI waveguide structure;

FIG. 2 is a graph of the temperature dependence of TE mode transmission for SOI waveguides with a polymer overlay as a function of waveguide widths;

FIG. 3 is a schematic drawing of a typical AWG;

FIG. 4 is a graph of the temperature dependence of the center wavelength in an exemplary 32 channel 100-GHz SOI AWG in which core width W=500 nm, over-cladding is SiO₂, with remaining parameters similar to those of FIG. 1;

FIG. 5 is a graph of the temperature dependence of the center wavelength in an exemplary 32 channel 100-GHz SOI AWG in which core width W=350 nm having a polymer over-cladding as shown in FIG. 1;

FIG. 6 shows an exemplary structure resulting from typical Front-End-of-Line (FEOL) integration;

FIG. 7 shows an exemplary structure resulting from typical Back-End-of-Line (BEOL) integration;

FIG. 8 is a schematic view of an exemplary athermal silicon photonics AWG (Type I) in accordance with one aspect of the present invention;

FIG. 9 is a cross-sectional view showing an exemplary Si-wire waveguide with a typical core width (W=500 nm);

FIG. 10 is a cross-sectional view showing an exemplary Si-wire waveguide with a broader core width (Ŵ=1,000 nm) in accordance with the present invention;

FIG. 11 is a schematic view of an exemplary athermal silicon photonics AWG (Type II) in accordance with another aspect of the present invention;

FIG. 12 is a cross-sectional view showing an exemplary Si-wire waveguide with a typical core structure;

FIG. 13 is a cross-sectional view showing an exemplary Si-wire waveguide with a slotted core structure in accordance with the present invention;

FIG. 14 is a schematic view of an exemplary reflection-type athermal silicon photonics AWG (Type III) in accordance with another aspect of the present invention; and

FIG. 15 is a schematic view of an exemplary reflection-type athermal silicon photonics AWG (Type IV) in accordance with another aspect of the present invention.

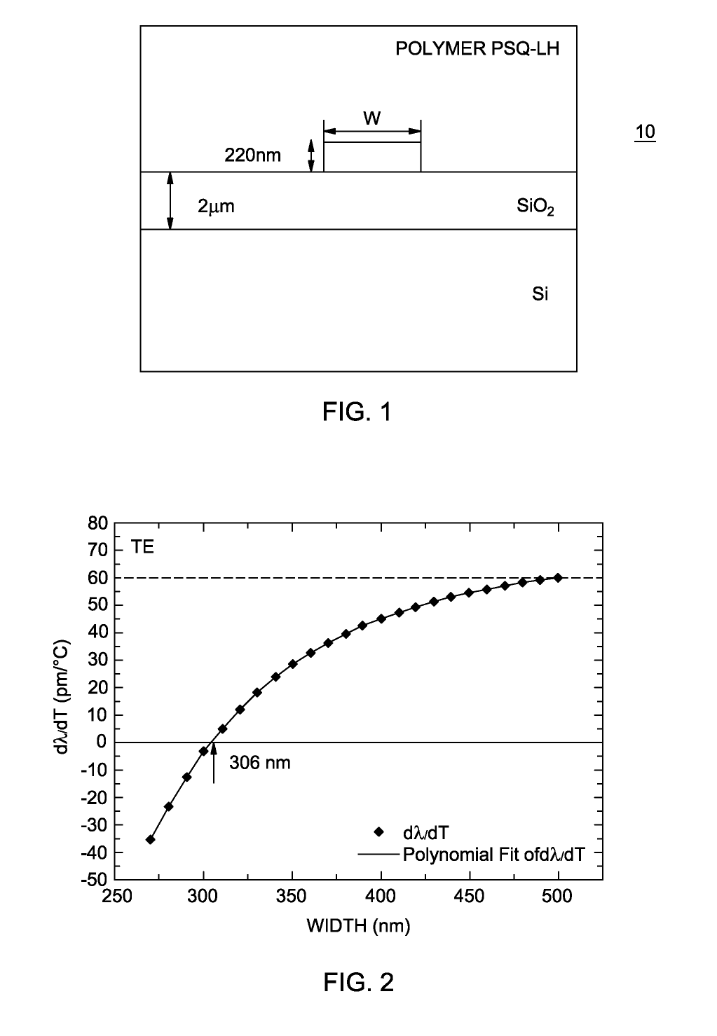

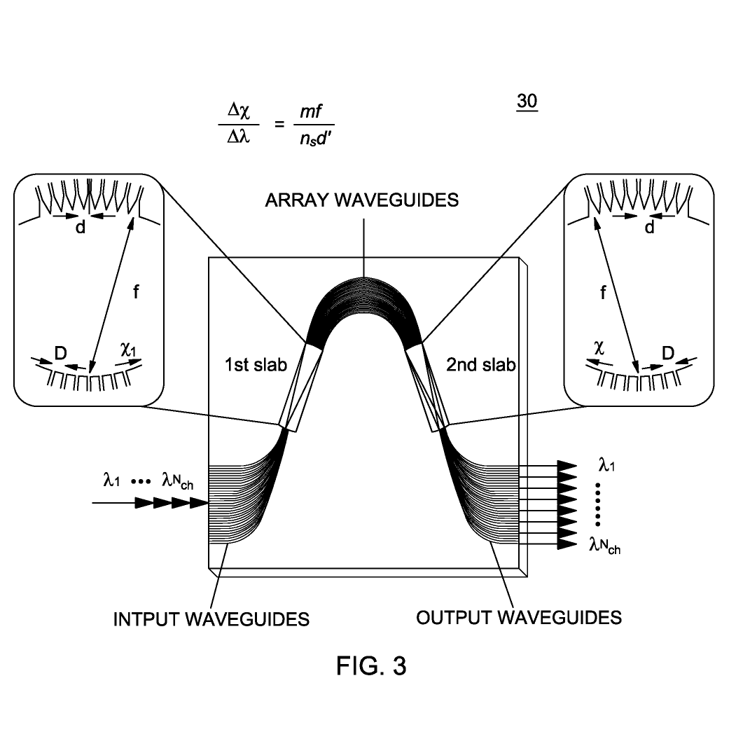

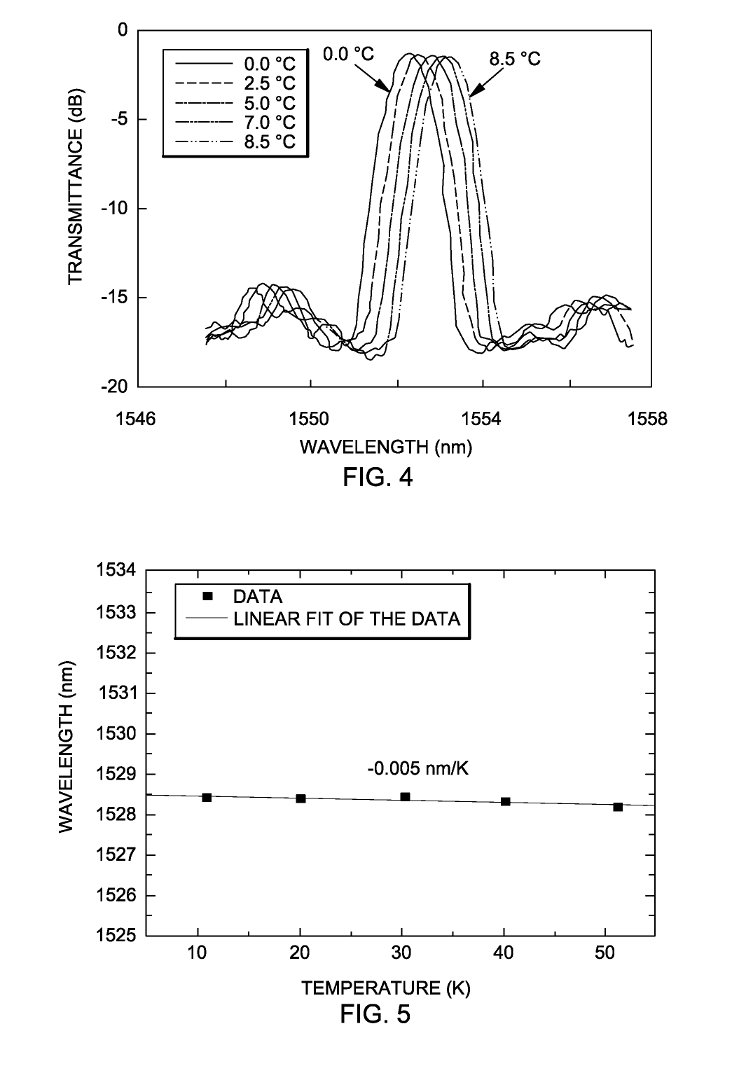

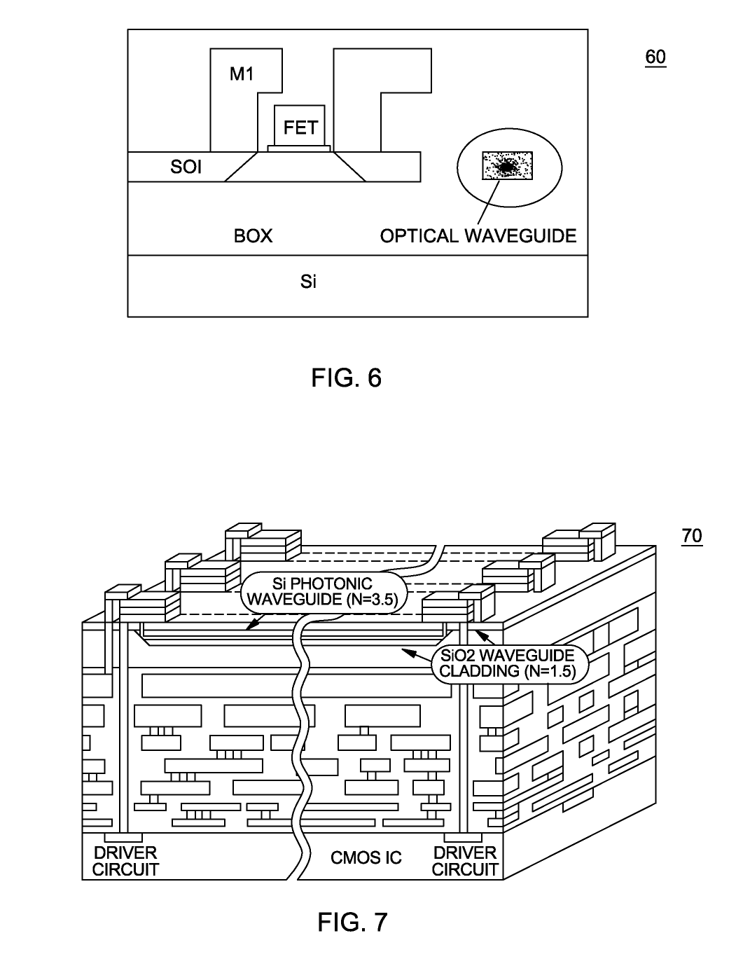

### DETAILED DESCRIPTION OF THE INVENTION

As discussed below, the present invention, in one aspect, provides athermal silicon photonics AWGs and methods of their manufacture using CMOS-compatible materials.

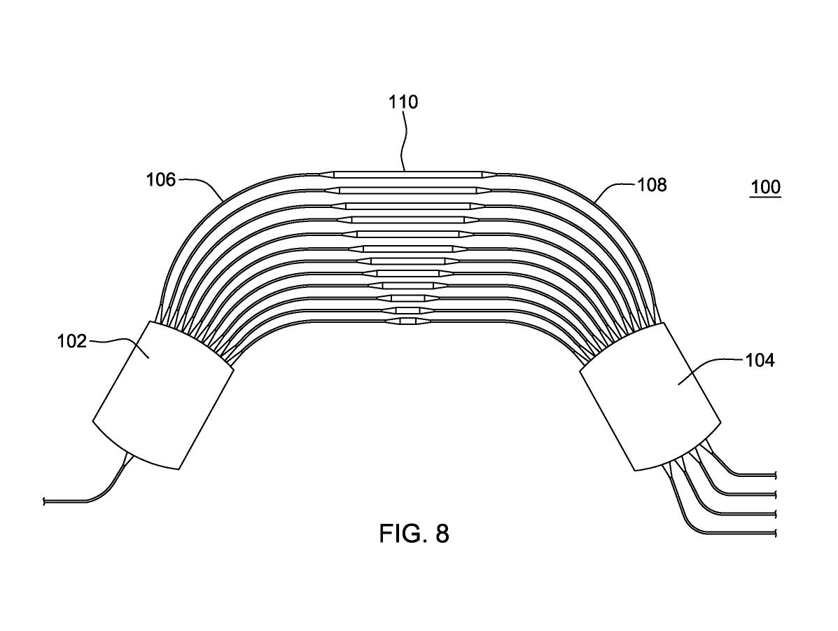

FIG. 8 is a schematic configuration of an entirely CMOS-compatible athermal AWG 100 employing two different core geometries (e.g., Si-wire waveguides with normal and broad core widths) in the array waveguides.

This “Type I” athermal AWG 100 includes, e.g., input/output waveguides leading to/from two focusing slab regions (102 and 104) and a phased-array of multiple channel waveguides 106/108/110. The array waveguides include waveguides having, e.g., two different core geometries. In this example, they are Si-wire waveguides 106 and 108 with a first (e.g., normal) core width (e.g., W=500 nm) and Si-wire waveguides 110 with a different, broader core width (e.g., Ŵ=1,000 nm), respectively. Core thickness is T=250 nm in this exemplary embodiment. As one example, the geometrical path lengths of the Si-wire waveguides with normal core widths (106 and 108) may increase by an increment Δl from the outer to the inner waveguide; and those of the Si-wire waveguides with broad core width (110) may decrease by an increment of Δs from the outer to the inner waveguide. The phase matching condition for the central wavelength λ is given by:

$$\frac{2 π}{λ} {n}_{c} [ {1}_{1} + ( i - 1 ) Δ 1 ] + \frac{2 π}{λ} {\hat{n}}_{c} [ {s}_{1} - ( i - 1 ) Δ s ] = \frac{2 π}{λ} {n}_{c} ( {1}_{1} + i Δ 1 ) + \frac{2 π}{λ} {\hat{n}}_{c} ( {s}_{1} - i Δ s ) + 2 m π , \qquad ( 4 )$$

where n_{c} and \hat{n}_{c} are effective indices of the Si-wire waveguide with normal core width and broad core width and l₁ and s₁ denote the outermost (i=1) path length of the normal core width and broad core width, respectively. Subtracting common terms in Eq. (4), the following expression is obtained:

$$λ = \frac{{\hat{n}}_{c} Δ s - {n}_{c} Δ 1}{m} . \qquad ( 5 )$$

Comparing Eq. (5) with (2), it is convenient to rewrite (5) into:

$$\begin{matrix}Δ L = \frac{{\hat{n}}_{c} Δ s - {n}_{c} Δ 1}{{n}_{c}} , & ( 6 ) \\ λ = \frac{{n}_{c} Δ L}{m} , & ( 7 )\end{matrix}$$

because ΔL is determined by the system specifications independently of the athermal conditions.

An athermal condition is derived from Eq. (5) as:

$$\frac{d λ}{d T} = \frac{1}{m} ( \frac{d {\hat{n}}_{c}}{d T} Δ s - \frac{d {n}_{c}}{d T} Δ 1 ) = 0 , \qquad ( 8 )$$

where d n_{c}/dT and d \hat{n}_{c}/dT denote temperature sensitivities of the Si-wire waveguides with normal core width and broad core width, respectively. Path length differences Δl and Δs in the Si-wire waveguides with normal core width and broad core width are obtained from Eqs. (5)-(8) as:

$$\begin{matrix}Δ s = \frac{Δ L}{( \frac{{\hat{n}}_{c}}{{n}_{c}} - \frac{d {\hat{n}}_{c} / d T}{d {n}_{c} / d T} )} . & ( 9.1 ) \\ Δ 1 = \frac{Δ L}{( \frac{{\hat{n}}_{c}}{{n}_{c}} \frac{d {n}_{c} / d T}{d {\hat{n}}_{c} / d T} - 1 )} , & ( 9.2 )\end{matrix}$$

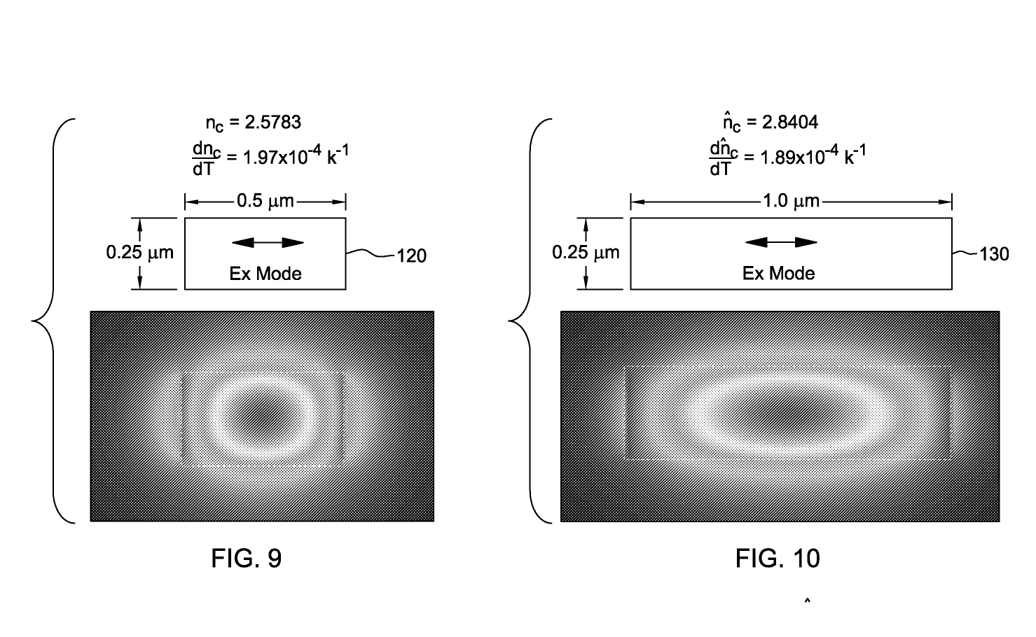

FIGS. 9 and 10 are cross-sectional views of exemplary waveguide configurations, electric field distributions, effective indices (n_{c}=2.5783 and \hat{n}_{c}=2.8404) and their temperature sensitivities (d n_{c}/dT=1.97×10⁻⁴ K⁻¹ and d \hat{n}_{c}/dT=1.89×10⁻⁴ K⁻¹) of Si-wire waveguides with normal core width 120 (w=500 nm) and Si-wire waveguides with broad core width 130 (Ŵ=1,000 nm), respectively.

Setting ΔL=12.451 μm for a 32ch-100 GHz AWG with effective indices (n_{c}=2.5783 and \hat{n}_{c}=2.8404) and their temperature sensitivities (d n_{c}/dT=1.97×10⁻⁴ K⁻¹ and d \hat{n}_{c}/dT=1.89×10⁻⁴ K⁻¹) in Eq. (9), exemplary path length differences Δl and Δs in the Si-wire waveguides with normal core width and broad core width are determined as

Δs=89.90 μm, (10.1)

Δl=86.59 μm. (10.2)

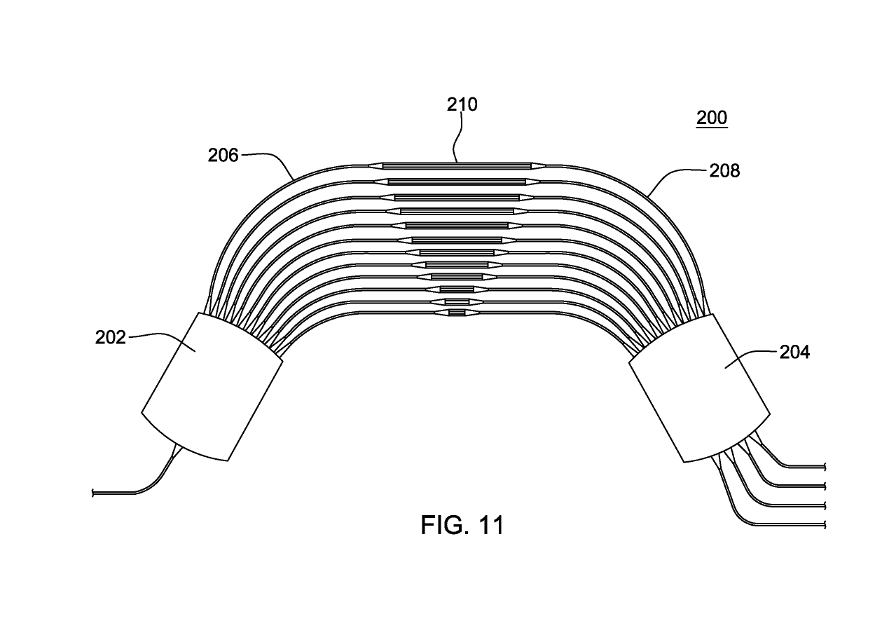

In accordance with another aspect of the present invention, FIG. 11 is a schematic of an entirely CMOS-compatible athermal AWG 200 employing two different core geometries (e.g., Si-wire and Si-slot waveguides) in the array waveguides.

This “Type II” athermal AWG 200 includes, e.g., input/output waveguides leading to/from two focusing slab regions (202 and 204) and a phased-array of multiple channel waveguides 206/208/210. In this “Type II” embodiment, the array waveguides include two different core geometries. In this example, they are Si-wire waveguides 206/208 (W=500 nm) having, e.g., a homogenous waveguide structure, and Si-slot waveguides 210 having an exemplary slot width (sₗₒₜ=150 nm) sandwiched between two silicon waveguides with the width of dₗₒₜ=175 nm, respectively. Core thickness is, e.g., T=250 nm.

The Si-slot waveguide structure may be based on a low-refractive-index sub-100 nm˜200 nm slot (such as air and SiO₂) formed between two silicon waveguides. The principle of operation of this structure is based on the boundary condition applied to the slot waveguides. The boundary condition indicates that the electric displacement field (D) be continuous across the silicon-air (or silicon-SiO₂) interface. For an electromagnetic wave propagating in the z-direction, the electric field component of the Eₓ mode (which is aligned in the x direction) undergoes a discontinuity that is proportional to the square of the ratio between the refractive indices of the silicon and the low-refractive-index slot. This discontinuity is such that the field is much more intense in the low-refractive-index slot region than in the silicon waveguides. Given that the width of the slot is comparable to the decay length of the field, the electrical field remains high across the slot, resulting in a power density in the slot that is much higher than that in the silicon regions. The percentage of power transmitted in a slot can be higher than 30% of the total guided power. The evanescent tails of the electromagnetic fields that are propagating in the silicon waveguides overlap in the central slot, which leads to a strong light confinement in the low index region. The net effect is a stronger intensity in the slot relative to the intensity in the silicon regions. The high confinement modes in the slot region are part of the true eigenmodes of the waveguide. Therefore, slot-waveguide modes are theoretically lossless assuming that there is no absorption nor scattering points along the structures. The low-loss property of Si-slot waveguides allows sufficient interaction between material in the slot and electric field over long propagation lengths. This is a significant advantage over plasmonic metal-slot waveguides in which the theoretical propagation length is of the order of 20 μm (G. Veronis and S. Fan, “Guided Subwavelength Plasmonic Mode Supported by a Slot in a Thin Metal Film”, Opt. Lett., vol. 30, no. 24, pp. 3359-3361, December 2005). Due to the strong intensity in the gap region of the Si-slot waveguide, insertion of another material in this gap region can strongly influence the optical characteristic of the waveguide. An insertion of biological material or human breath in this gap region will allow strong interaction with the propagating wave and allow a large phase change at relatively low material content.

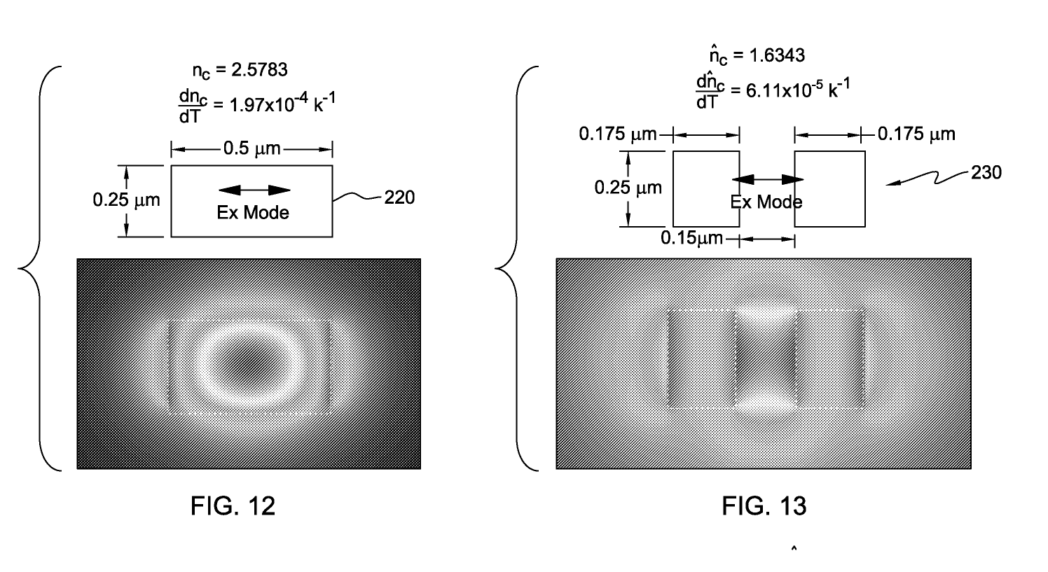

FIGS. 12 and 13 are cross-sectional views of exemplary waveguide configurations, electric field distributions, effective indices (n_{c}=2.5783 and \hat{n}_{c}=1.6343) and their temperature sensitivities (d n_{c}/dT=1.97×10⁻⁴ K⁻¹ and d \hat{n}_{c}/dT=6.11×10⁻⁵ K⁻¹) of an Si-wire waveguide 220 and Si-slot waveguide 230, respectively.

Setting ΔL=12.451 μm for a 32ch-100 GHz AWG and effective indices (n_{c}=2.5783 and \hat{n}_{c}=1.6343) and their temperature sensitivities (d n_{c}/dT=1.97×10⁻⁴ K⁻¹ and d \hat{n}_{c}/dT=6.11×10⁻⁵ K⁻¹) in Eq. (9), path length differences Δl and Δs in the Si-wire waveguides with normal core width and broad core width (e.g., slotted) are determined as:

Δs=38.55 μm, (11.1)

Δl=11.98 μm. (11.2)

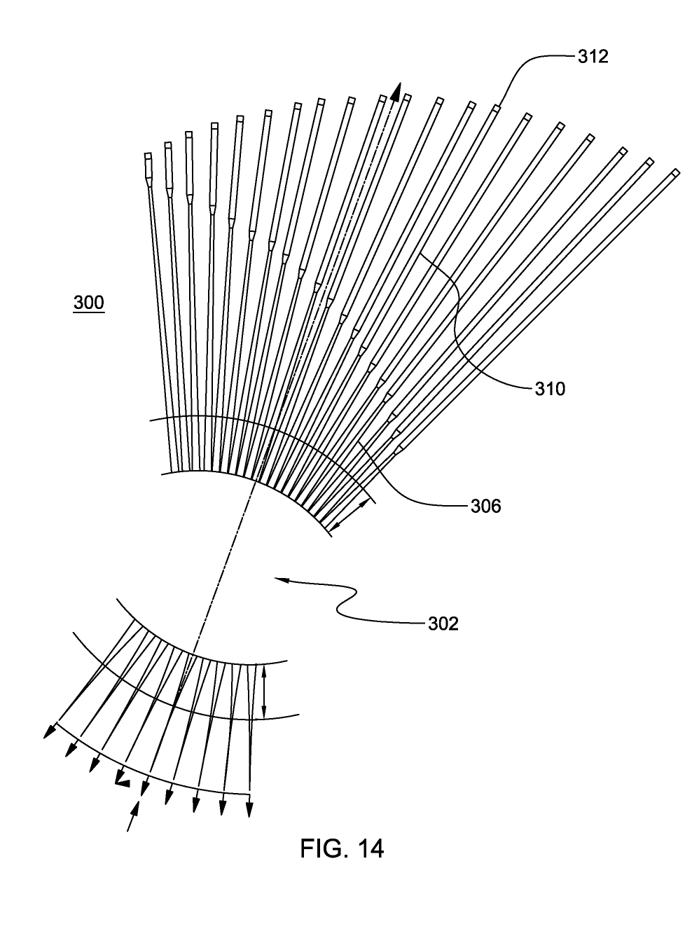

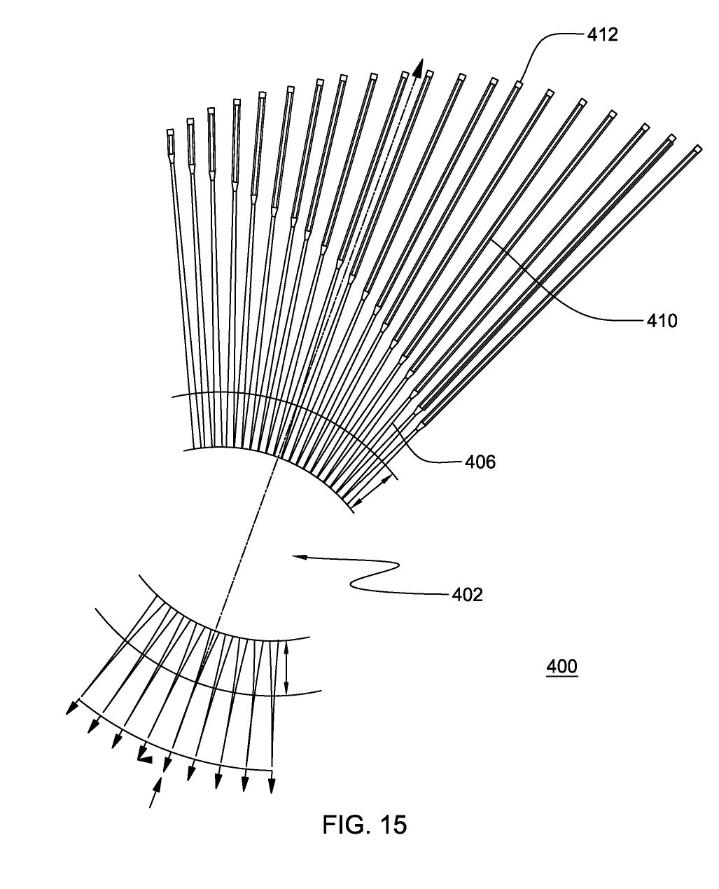

In accordance with another aspect of the present invention, FIG. 14 is a schematic of an entirely CMOS compatible, reflection-type athermal AWG 300 employing two different core geometries (e.g., Si-wire waveguides with normal 306 and broad 310 core widths) in the array waveguides.

In this “Type III” athermal AWG, essentially half of the Type I AWG 100 of FIG. 8 is implemented using a single slab region 302. At the end of each array waveguide, a mirror 312, e.g., gold mirror or DBR (distributed Bragg reflector) mirror, is located to reflect back the incoming lightwave.

In this Type III athermal AWG, geometrical path length of the Si-wire waveguide with normal core width (e.g., W=500 nm) decreases with the increment of Δl^{(r)} from the left-hand side to the right-hand side waveguide and that of the Si-wire waveguide with broad core width (e.g., Ŵ=1,000 nm) increases with the increment of Δs^{(r)} from the left-hand side to the right-hand side waveguide. The phase matching condition for the central wavelength λ is given by:

$$\frac{2 π}{λ} {n}_{c} 2 \times [ {1}_{1} - ( i - 1 ) Δ {1}^{( r )} ] + \frac{2 π}{λ} {\hat{n}}_{c} 2 \times [ {s}_{1} + ( i - 1 ) Δ {s}^{( r )} ] = \frac{2 π}{λ} {n}_{c} 2 \times [ {1}_{1} - i Δ {1}^{( r )} ] + \frac{2 π}{λ} {\hat{n}}_{c} 2 \times [ {s}_{1} + i Δ {s}^{( r )} ] - 2 m π , \qquad ( 12 )$$

where n_{c} and \hat{n}_{c} are effective indices of the Si-wire waveguides with normal and broad core widths and l₁ and s₁ denote the leftmost (i=1) path length of the normal and broad core widths, respectively. Subtracting common terms in Eq. (12), the following expression is obtained:

$$λ = \frac{{\hat{n}}_{c} 2 Δ {s}^{( r )} - {n}_{c} 2 Δ {1}^{( r )}}{m} . \qquad ( 13 )$$

Comparing Eq. (13) with (2), it is convenient to rewrite (13) into:

$$\begin{matrix}Δ L = \frac{{\hat{n}}_{c} 2 Δ {s}^{( r )} - {n}_{c} 2 Δ {1}^{( r )}}{{n}_{c}} , & ( 14 ) \\ λ = \frac{{n}_{c} Δ L}{m} , & ( 15 )\end{matrix}$$

because ΔL is determined by the system specifications independently of the athermal conditions.

An athermal condition is derived from Eq. (13) as:

$$\frac{d λ}{d T} = \frac{2}{m} [ \frac{d {\hat{n}}_{c}}{d T} Δ {s}^{( r )} - \frac{d {n}_{c}}{d T} Δ {1}^{( r )} ] = 0 , \qquad ( 16 )$$

where d n_{c}/dT and d \hat{n}_{c}/dT denote temperature sensitivities of the Si-wire waveguides with normal and broad core widths. Path length differences Δl^{(r)} and Δs^{(r)} in the Si-wire and Si-slot waveguides are obtained from Eqs. (13)-(16) as:

$$\begin{matrix}Δ {s}^{( r )} = \frac{Δ L}{2 ( \frac{{\hat{n}}_{c}}{{n}_{c}} - \frac{d {\hat{n}}_{c} / d T}{d {n}_{c} / d T} )} . & ( 17.1 ) \\ Δ {1}^{( r )} = \frac{Δ L}{2 ( \frac{{\hat{n}}_{c}}{{n}_{c}} \frac{d {n}_{c} / d T}{d {\hat{n}}_{c} / d T} - 1 )} , & ( 17.2 )\end{matrix}$$

Setting ΔL=12.451 μm for a 32ch-100 GHz AWG and effective indices (n_{c}=2.5783 and \hat{n}_{c}=2.8404) and their temperature sensitivities (d n_{c}/dT=1.97×10⁴ K⁻¹ and d \hat{n}_{c}/dT=1.89×10⁻⁴ K⁻¹) in Eq. (17), path length differences Δl^{(r)} and Δs^{(r)} in the Si-wire waveguide with normal core width and broad core widths are determined as

Δs^{(r)}=44.95 μm, (18.1)

Δl^{(r)}=43.29 μm. (18.2)

In accordance with another aspect of the present invention, FIG. 15 is a schematic of an entirely CMOS-compatible reflection-type athermal AWG 400 employing two different core geometries (e.g., Si-wire 406 and Si-slot waveguides 412) in the array waveguides.

In this “Type IV” athermal AWG 400, essentially half of the Type II AWG 200 of FIG. 11 is implemented using a single slab region 402. At the end of each array waveguide, a mirror 412, e.g., gold mirror or DBR (distributed Bragg reflector) mirror, is located to reflect back the incoming lightwave.

In this Type IV athermal AWG, the geometrical path length of the Si-wire waveguides decrease with the increment of Δl from the left-hand side to the right-hand side waveguide and that of the Si-slot waveguides increases with the increment of Δs from the left-hand side to the right-hand side waveguide.

Setting ΔL=12.451 μm for a 32ch-100 GHz AWG and effective indices (n_{c}=2.5783 and \hat{n}_{c}=1.6343) and their temperature sensitivities (d n_{c}/dT=1.97×10⁻⁴ K⁻¹ and d \hat{n}_{c}/dT=6.11×10⁻⁵ K⁻¹) in Eq. (17), path length differences Δl^{(r)} and Δs^{(r)} in the Si-wire waveguide with normal core width and broad core width (e.g., slotted) are determined as:

Δs^{(r)}=19.28 μm, (19.1)

Δl^{(r)}=5.99 μm. (19.2)

Various combinations of different core sizes and/or different core structures (broadly connoted as different core features) may be implemented, and also fall within the scope of the present invention. CMOS fabrication techniques can be used to arrive at the structures of the present invention. By providing differing core features, including different sizes and/or structures across the waveguide paths, the aforementioned advantages of athermal construction and operation can be obtained in accordance with the present invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A silicon photonics array waveguide grating, comprising:
a plurality of silicon photonics array waveguides running from at least one of an input and output slab waveguide region, wherein:
first sections of each of the plurality of array waveguides have a first core geometry; and
second sections of each of the plurality of array waveguides have a second core geometry.

2. The array waveguide grating of claim 1, wherein the first and second core geometries comprise different waveguide core widths.

3. The array waveguide grating of claim 2, wherein the second section of each of the plurality of array waveguides is a central section thereof.

4. The array waveguide grating of claim 3, wherein the second core size is greater than the first core size, and the path length of the plurality of array waveguides increases from an outer to an inner waveguide and the path length of each second section of each of the plurality of array waveguides decreases from the outer to the inner waveguide.

5. The array waveguide grating of claim 1, wherein the first core geometry comprises a homogenous waveguide structure and the second core structure comprises a slot waveguide structure.

6. The array waveguide grating of claim 5, wherein the second section of each of the plurality of array waveguides is a central section thereof.

7. The array waveguide grating of claim 6, wherein the path length of the plurality of array waveguides increases from an outer to an inner waveguide and the path length of each second section of each of the plurality of array waveguides decreases from the outer to the inner waveguide.

8. The array waveguide grating claim 1, comprising a reflection-type array waveguide grating.

9. A method of forming a silicon photonics array waveguide grating, comprising:
forming a plurality of silicon photonics array waveguides running from at least one of an input and output slab waveguide region, wherein:
first sections of each of the plurality of array waveguides have a first core geometry; and
second sections of each of the plurality of array waveguides have a second core geometry.

10. The method of claim 9, wherein the first and second core geometries comprise different waveguide core widths.

11. The method of claim 10, wherein the second section of each of the plurality of array waveguides is a central section thereof.

12. The method of claim 11, wherein the second core size is greater than the first core size, and the path length of the plurality of array waveguides increases from an outer to an inner waveguide and the path length of each second section of each of the plurality of array waveguides decreases from the outer to the inner waveguide.

13. The method of claim 9, wherein the first core geometry comprises a homogenous waveguide structure and the second core structure comprises a slot waveguide structure.

14. The method of claim 13, wherein the second section of each of the plurality of array waveguides is a central section thereof.

15. The method of claim 14, wherein the path length of the plurality of array waveguides increases from an outer to an inner waveguide and the path length of each second section of each of the plurality of array waveguides decreases from the outer to the inner waveguide.

16. The method of claim 9, wherein the array waveguide grating comprises a reflection-type array waveguide grating.
